(19) United States
(12) Patent Application Publication
(10) Pub. No.: US 2026/0106681 A1
(43) Pub. Date: Apr. 16, 2026

(54) SATELLITE IoT SYSTEM, AIR COMMUNICATION NODE, AND METHOD FOR PROCESSING DATA IN SATELLITE IoT SYSTEM

(71) Applicant: ELECTRONICS AND TELECOMMUNICATIONS RESEARCH INSTITUTE, Daejeon (KR)

(72) Inventors: Soo Yeob Jung, Daejeon (KR); Myung Soon Kim, Daejeon (KR); Hee Wook Kim, Daejeon (KR); Mi Kyung Oh, Daejeon (KR); Joon Gyu Ryu, Daejeon (KR); Sang Jae Lee, Daejeon (KR); Tae Chul Hong, Daejeon (KR)

(21) Appl. No.: 19/325,871

(22) Filed: Sep. 11, 2025

(30) Foreign Application Priority Data
Oct. 14, 2024 (KR) 10-2024-0139863

(51) Int. Cl. H04B 17/391; H04B 17/20; H04L 5/00; H04L 25/02

(52) U.S. Cl. CPC H04B 17/391; H04B 17/253; H04L 5/0048; H04L 25/0204

(57) ABSTRACT

The present invention relates to a satellite Internet on things (IoT) system, an air communication node, and a data processing method in a satellite IoT system. The IoT system according to an aspect of the present invention includes a plurality of IoT terminals transmitting pilot data and sensor data, an air communication node including a first edge server, receiving an echo signal for the pilot data, estimating terrestrial-air channel state information based on the echo signal, collecting sensor data based on the estimated channel state information, and classifying the collected sensor data into processable sensor data and unprocessable sensor data, and a satellite including a second edge server, processing the unprocessable sensor data offloaded from the air communication node, and transmitting the processed data to the air communication node.

### CROSS-REFERENCE TO RELATED APPLICATION

This application claims priority to and the benefit of Korean Patent Application No. 10-2024-0139863, filed on Oct. 14, 2024, the disclosure of which is incorporated herein by reference in its entirety.

### BACKGROUND

### 1. Field of the Invention

The present invention relates to a satellite Internet on things (IoT) system, an air communication node, and a data processing method in a satellite IoT system that applies joint communication and sensing and a space-air-ground integrated network.

### 2. Discussion of Related Art

The 6G communication network may support various communication services and scenarios compared to the 5G communication network. The 6G communication network may satisfy requirements of ultra-performance, ultra-bandwidth, ultra-space, ultra-precision, ultra-intelligence, and/or ultra-reliability. The 6G communication network may support various wide frequency bands and may be applied to various usage scenarios (e.g., terrestrial communication, non-terrestrial communication, sidelink communication, etc.).

The communication network (e.g., a 5G communication network, a 6G communication network, etc.) may provide communication services to terminals located on the ground. The demand for communication services for airplanes, drones, and satellites located at places other than the ground as well as those located on the ground is increasing. To this end, technologies for a non-terrestrial network (NTN) are being discussed. A non-terrestrial network may be implemented based on 5G communication technology, 6G communication technology, etc. For example, in a non-terrestrial network, communication between a satellite and a terrestrial communication node or a non-terrestrial communication node (e.g., an aircraft, a drone, etc.) may be performed based on 5G communication technology, 6G communication technology, etc. In a non-terrestrial network, a satellite may perform functions of a base station in a communication network (e.g., a 5G communication network, a 6G communication network, etc.).

The background art of the present invention is disclosed in Korean Patent Registration No. 10-1702807 (published on Feb. 3, 2017).

### SUMMARY OF THE INVENTION

The present invention is directed to providing a satellite Internet on things (IoT) system, an air communication node, and a data processing method in a satellite IoT system that applies joint communication and sensing and a space-air-ground integrated network.

According to an aspect of the present invention, there is provided a satellite Internet on things (IoT) system, including: a plurality of IoT terminals transmitting pilot data and sensor data; an air communication node including a first edge server, receiving an echo signal for the pilot data, estimating terrestrial-air channel state information based on the echo signal, collecting sensor data based on the estimated channel state information, and classifying the collected sensor data into processable sensor data and unprocessable sensor data; and a satellite including a second edge server, processing the unprocessable sensor data offloaded from the air communication node, and transmitting the processed data to the air communication node.

The air communication node may be an unmanned aerial vehicle.

A joint communication and sensing framework may be applied between each IoT terminal and the air communication node.

Each of the IoT terminal may transmit the pilot data during a pilot section of a data frame, and transmits the sensor data during a data section.

The IoT terminal may transmit the pilot data in a direction of a terrestrial target, and the echo signal may include at least one of a first echo signal reflected from the terrestrial target and a second echo signal reflected from clutter.

The air communication node may estimate the channel state information based on a difference between a predefined pilot pattern and the echo signal.

The air communication node may calculate energy consumption consumed for processing the corresponding sensor data based on a size of each piece of the collected sensor data, compare the size and energy consumption of each piece of sensor data with data processing capacity and energy consumption of the first edge server, and determine the processable sensor data and the unprocessable sensor data based on the comparison result.

The air communication node may process the processable sensor data, receive data processed by the satellite, and transmit the processed data and the data processed by the satellite to an end user when the air communication node reaches the sky above the end user which is a final destination.

According to another aspect of the present invention, there is provided an air communication node, including: a communication module; a memory; and a processor connected to the communication module and the memory, in which the processor receives an echo signal through the communication module, estimates terrestrial-air channel state information based on the echo signal, collects sensor data based on the estimated channel state information, classifies processable sensor data and unprocessable sensor data based on the collected sensor data, offloads the unprocessable sensor data to a satellite through the communication module, processes the processable sensor data, and receives data processed by the satellite.

The echo signal may be a signal in which pilot data transmitted from an IoT terminal is reflected from at least one of a terrestrial target and clutter.

The processor may estimate the channel state information based on a difference between a predefined pilot pattern and the echo signal.

The processor may calculate energy consumption consumed for processing the corresponding sensor data based on a size of each piece of the collected sensor data, compare the size and energy consumption of each piece of sensor data with preset data processing capacity and energy consumption, and determine the processable sensor data and the unprocessable sensor data based on the comparison result.

The processor may transmit the processed data and the data processed by the satellite to an end user when the processor reaches the sky above the end user which is a final destination.

According to still another aspect of the present invention, there is provided a method of processing data in a satellite Internet on things (IoT) system, including: transmitting, by each of a plurality of IoT terminals, pilot data and sensor data; receiving, by an air communication node, an echo signal for the pilot data and estimating terrestrial-air channel state information based on the echo signal; collecting, by the air communication node, sensor data based on the estimated channel state information; classifying, by the air communication node, the collected sensor data into processable sensor data and unprocessable sensor data; and offloading, by the air communication node, the unprocessable sensor data to a satellite.

In the transmitting, each of the IoT terminals may transmit the pilot data during a pilot section of a data frame, and transmit the sensor data during a data section.

The echo signal may include at least one of a first echo signal reflected from a terrestrial target and a second echo signal reflected from clutter.

In the estimating of the terrestrial-air channel state information, the air communication node may estimate the channel state information based on a difference between a predefined pilot pattern and the echo signal.

In the classifying, the air communication node may calculate energy consumption consumed for processing the corresponding sensor data based on a size of each piece of the collected sensor data, compare the size and energy consumption of each piece of sensor data with preset data processing capacity and energy consumption, and determine the processable sensor data and the unprocessable sensor data based on the comparison result.

The method may further include, after the offloading, processing, by the air communication node, the processable sensor data and receiving the data processed by the satellite.

The method may further include, after receiving the data processed by the satellite, transmitting, by the air communication node, the processed data and the data processed by the satellite to an end user when the air communication node reaches the sky above the end user which is a final destination.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing a satellite Internet on things (IoT) system according to an embodiment of the present invention;

FIG. 2 is an exemplary diagram for describing a data frame for joint communication and sensing according to an embodiment of the present invention;

FIG. 3 is a block diagram schematically illustrating a configuration of an unmanned aerial vehicle according to an embodiment of the present invention; and

FIG. 4 is a flowchart for describing a method of processing data in a satellite IoT system according to an embodiment of the present invention.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, an embodiment of a satellite Internet on things (IoT) system, an air communication node, and a method of processing data in a satellite IoT system according to an embodiment of the present invention will be described.

The importance of satellite IoT systems in the upcoming 6G era has grown significantly due to the development of non-terrestrial networks through aviation and satellites, and satellite IoT technology is being applied in fields such as environmental protection, military reconnaissance, and maritime transportation. In addition, much research has been conducted on joint communication and sensing that may maximize the efficiency of resource use by performing communication and sensing simultaneously.

The present invention relates to a technology that may apply joint communication and sensing and a space-air-ground integrated network to a satellite IoT system to efficiently utilize communication resources such as energy, hardware, algorithms, and a signal processing process and minimize energy consumption of an air communication node (unmanned aerial vehicle 200).

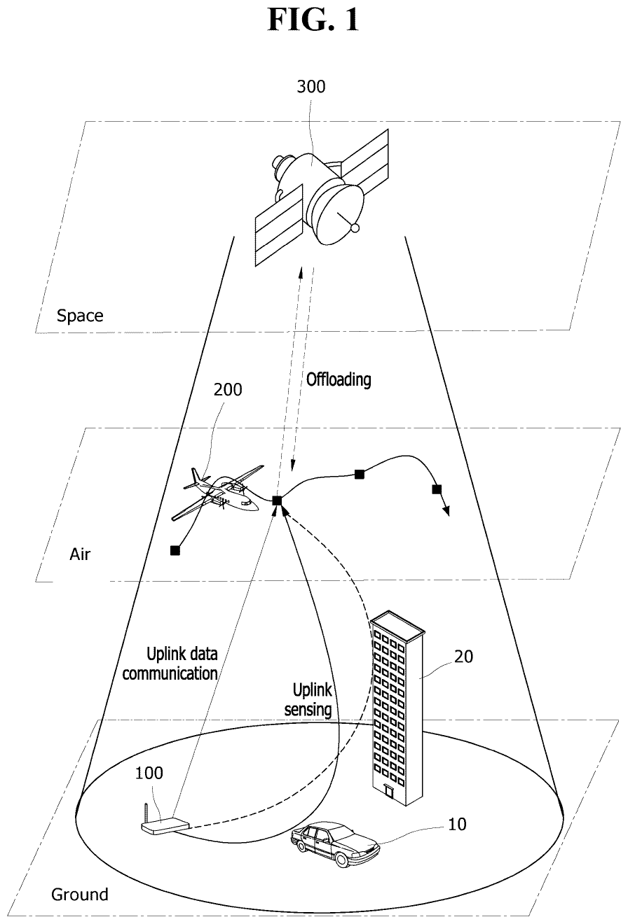

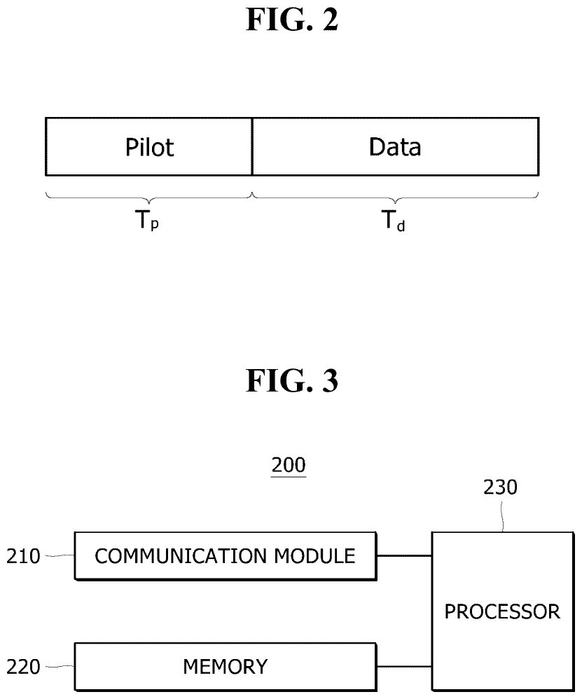

FIG. 1 is a diagram for describing a satellite IoT system according to an embodiment of the present invention, and FIG. 2 is an exemplary diagram for describing a data frame for joint communication and sensing according to an embodiment of the present invention.

Referring to FIG. 1, a satellite IoT system according to an embodiment of the present invention includes a plurality of IoT terminals 100, an air communication node 200, and a satellite 300, and may utilize a network that integrates space, air, and terrestrial networks.

A joint communication and sensing framework may be applied between each IoT terminal 100 and the air communication node 200. A data frame for joint communication and sensing may be composed of a pilot section Tp and a data section Td, as illustrated in FIG. 2.

The plurality of IoT terminals 100 are communication nodes located on the ground, and each IoT terminal 100 may transmit pilot data and sensor data. In this case, each IoT terminal 100 may transmit the pilot data during a pilot section Tp of a data frame, and transmit the sensor data during a data section Td.

The IoT terminal 100 may transmit the pilot data in all directions. To find a terrestrial target 10, the IoT terminal 100 may transmit the pilot data toward the terrestrial target 10. Therefore, the pilot data transmitted by the IoT terminal 100 may be reflected by at least one of the terrestrial target 10 and clutter 20. The pilot data transmitted by the IoT terminal 100 may or may not be transmitted to the air communication node 200.

The IoT terminal 100 may transmit the sensor data to the air communication node 200 during the data section Td through uplink data communication.

The IoT terminal 100 may be, for example, an IoT sensor, a smartphone, a mobile computer, an intelligent vehicle, etc.

In FIG. 1, only one IoT terminal 100 is illustrated, but the satellite IoT system may include multiple IoT terminals 100.

The air communication node 200 includes a first edge server, and receives an echo signal for the pilot data, estimates terrestrial-air channel state information based on the echo signal, collects the sensor data based on the estimated channel state information, and determines processable sensor data and unprocessable sensor data based on a size of each piece of collected sensor data.

The air communication node 200 is a communication node located in the air, and may include, for example, an unmanned aerial vehicle (UAV), a drone, etc. Hereinafter, for convenience of description, the air communication node 200 will be described as an unmanned aerial vehicle.

The unmanned aerial vehicle 200 includes the first edge server, and thus may provide a mobile edge computing environment by applying an edge computing server function. The first edge server may provide a computing function for utilizing large-scale sensor data collected from the IoT terminal 100 in real time.

The unmanned aerial vehicle 200 may receive the echo signal for the pilot data. Here, the echo signal may include at least one of a first echo signal reflected from the terrestrial target 10 and a second echo signal reflected from the clutter 20. The second echo signal reflected from the clutter 20 may be an interference component.

The unmanned aerial vehicle 200 may estimate the terrestrial-air channel state information based on a difference between a predefined pilot pattern and the echo signal. Since the pilot pattern is predefined, the unmanned aerial vehicle 200 may estimate the terrestrial-air channel state information using the difference between the pilot pattern and the first echo signal. The unmanned aerial vehicle 200 may estimate the terrestrial-air channel state information more accurately using the difference between the pilot pattern and the first echo signal and the second echo signal.

The unmanned aerial vehicle 200 may collect the sensor data transmitted from the IoT terminal 100 based on the estimated channel state information. The channel state information enables the unmanned aerial vehicle 200 to receive sensor data transmitted during the data section with high probability.

The unmanned aerial vehicle 200 may process the sensor data collected in real time using the first edge server.

However, since the unmanned aerial vehicle 200 has a limited battery, the total energy consumption is limited, and as a result, the data processing capacity may be limited. Therefore, the unmanned aerial vehicle 200 needs to minimize the energy consumption of the unmanned aerial vehicle 200 by offloading the sensor data exceeding its data processing capacity to the satellite 300.

Accordingly, the unmanned aerial vehicle 200 may classify the collected sensor data into the processable sensor data and the unprocessable sensor data, and offload the unprocessable sensor data to the satellite 300.

To this end, the unmanned aerial vehicle 200 may calculate the energy consumption consumed for processing the corresponding sensor data based on the size of each piece of collected sensor data, and compare the size and energy consumption of each piece of sensor data with the data processing capacity and energy consumption of the first edge server. Here, since the data processing capacity and energy consumption of the first edge server are determined in advance, the unmanned aerial vehicle 200 may compare the size and energy consumption of the sensor data with the data processing capacity and energy consumption of the first edge server.

The unmanned aerial vehicle 200 may determine the sensor data exceeding the data processing capacity and energy consumption of the first edge server as the unprocessable sensor data and offload the unprocessable sensor data to the satellite 300.

The unmanned aerial vehicle 200 may process the processable sensor data through the first edge server. For example, when the sensor data is temperature and humidity data, the unmanned aerial vehicle 200 may calculate an average value of the temperature and humidity or train to predict the temperature or humidity in the future.

The unmanned aerial vehicle 200 may process the processable sensor data and receive the data processed by the satellite 300.

The unmanned aerial vehicle 200 stores self-processed data and the data processed by the satellite 300 during the flight, and when the unmanned aerial vehicle 200 reaches the sky above an end user (not illustrated) which is a final destination, the unmanned aerial vehicle 200 may transmit the self-processed data and the data processed by the satellite 300 to the end user. Here, the end user may include, for example, a cloud server, a base station, etc.

The end user may utilize the transmitted data as a final application.

The satellite 300 includes a second edge server, and processes the unprocessable sensor data offloaded from the unmanned aerial vehicle 200, and transmits the processed data to the unmanned aerial vehicle 200.

The satellite 300 may include the second edge server to apply an edge computing server function, thereby providing a mobile edge computing environment. The second edge server may provide a computing function for utilizing large-scale sensor data collected from the IoT terminal 100 in real time. The second edge server may have a larger data processing capacity than the first edge server mounted on the unmanned aerial vehicle 200.

The satellite 300 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS).

A service link may be established between the IoT terminal 100, the unmanned aerial vehicle 200, and the satellite 300, and the service link may be a radio link.

Meanwhile, in this embodiment, only the size of the sensor data is considered as a constraint for minimizing the energy usage of the unmanned aerial vehicle 200, but in addition to the size of the sensor data, data rates for terrestrial-air data transmission and air-satellite data transmission, a sensing signal to interference plus noise ratio (SINR), an offloading rate, etc., may be considered.

FIG. 3 is a block diagram schematically illustrating a configuration of the unmanned aerial vehicle according to an embodiment of the present invention.

Referring to FIG. 3, the unmanned aerial vehicle 200 according to an embodiment of the present invention includes a communication module, a memory, and a processor.

The communication module may provide a communication interface necessary to provide transmission and reception signals with an external device (such as the IoT terminal 100, the satellite 300, etc.) in the form of the packet data by linking with a communication network. In particular, the communication module may sense the pilot data through the joint communication and sensing, and transmit and receive the sensor data. In addition, the communication module may be a device including hardware and software necessary to transmit and receive signals, such as a control signal or a data signal through wired and wireless connections, to and from other network devices. In addition, the communication module may be implemented in various forms such as a short-range communication module, a wireless communication module, a mobile communication module, and a wired communication module.

The memory is a configuration that stores data related to the operation of the unmanned aerial vehicle 200. In particular, the memory may store a program (application or applet) that enables estimation of the terrestrial-air channel state information, a program (application or applet) that enables classification of the collected sensor data into the processable sensor data and the unprocessable sensor data, a program (application or applet) that enables offloading of the unprocessable sensor data, etc., and the stored information may be selectively selected by the processor as needed. The memory stores various types of data generated during the execution of an operating system or application (program or applet) for driving the unmanned aerial vehicle 200. In this case, “memory” collectively refers to a nonvolatile storage device that maintains stored information even when power is not supplied and a volatile storage device that requires power to maintain stored information. In addition, the memory may perform a function of temporarily or permanently storing data processed by the processor. Here, the memory may include a magnetic storage medium or a flash storage medium in addition to a volatile storage device that requires power to maintain stored information, but the scope of the present invention is not limited thereto.

The processor may be operatively connected to at least one of the communication module and the memory. The processor may be implemented as at least one of a central processing unit (CPU), an application specific integrated circuit (ASIC), a digital signal processor (DSP), a programmable logic device (PLD), a field programmable gate array (FPGA), a micro controller unit (MCU), and a system on chip (SoC), and may be configured to control a plurality of hardware or software components connected to the processor by driving the operating system or the application, perform various types of data processing and calculations, execute at least one command stored in the memory, and store data resulting from the execution in the memory.

The processor may receive the echo signal through the communication module, estimate the terrestrial-air channel state information based on the echo signal, collect the sensor data based on the estimated channel state information, classify the processable sensor data and the unprocessable sensor data based on the size of each piece of collected sensor data, and offload the unprocessable sensor data to the satellite 300 through the communication module.

Hereinafter, the operation of the processor will be described in detail.

The processor may receive the echo signal through the communication module. Here, the echo signal may include at least one of the first echo signal reflected from the terrestrial target 10 and the second echo signal reflected from the clutter 20.

The processor may estimate the terrestrial-air channel state information based on the difference between the predefined pilot pattern and the echo signal. Since the pilot pattern is predefined, the processor may estimate the terrestrial-air channel state information using the difference between the pilot pattern and the echo signal.

The processor may collect the sensor data transmitted from the IoT terminal 100 based on the estimated channel state information. The collected sensor data may exceed the data processing capacity of the unmanned aerial vehicle 200.

Therefore, the processor may classify the processable sensor data and the unprocessable sensor data based on the size of each piece of collected sensor data, and offload the unprocessable sensor data to the satellite 300 through the communication module.

That is, the processor may calculate the energy consumption consumed for processing the corresponding sensor data based on the size of each piece of collected sensor data, and compare the size and energy consumption of each piece of sensor data with the data processing capacity and energy consumption of the first edge 4server. The processor may determine the sensor data exceeding the data processing capacity and energy consumption of the first edge server as the unprocessable sensor data.

The processor may process the processable data on its own and offload the unprocessable sensor data to the satellite 300. The processor may receive the data processed by the satellite 300.

The processor stores the self-processed data and the data processed by the satellite 300 during the flight, and when the processor reaches the sky above the end user, which is the final destination, the processor may transmit the self-processed data and the data processed by the satellite 300 to the end user.

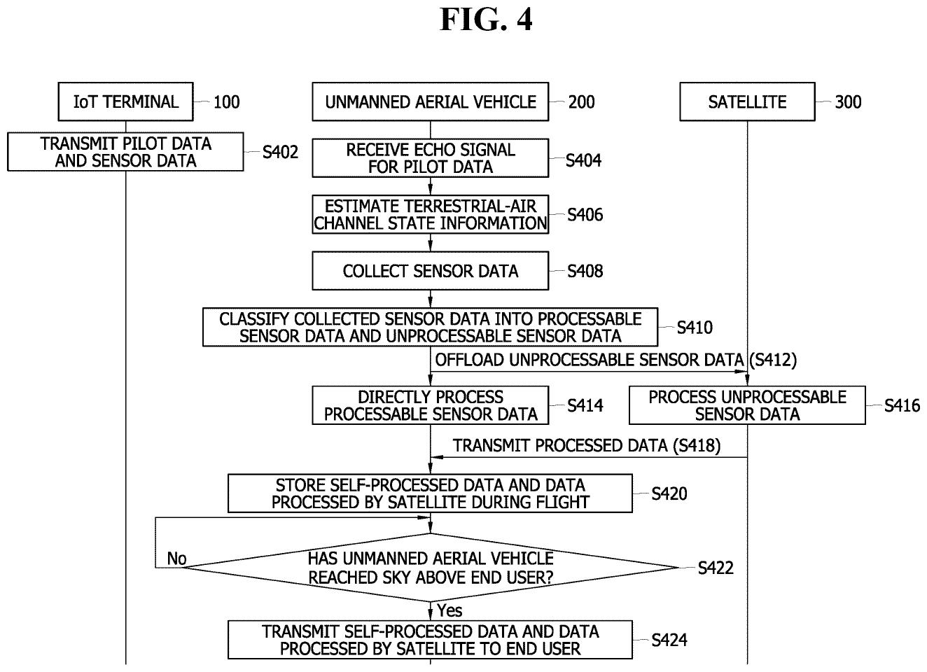

FIG. 4 is a flowchart explaining a method of processing data in a satellite IoT system according to an embodiment of the present invention.

Referring to FIG. 4, the IoT terminal 100 transmits the pilot data and the sensor data (S402). In this case, the IoT terminal 100 may transmit the pilot data during the pilot section Tp of the data frame and the sensor data during the data section Td.

When operation S402 is performed, the unmanned aerial vehicle 200 receives the echo signal for the pilot data (S404) and estimates the terrestrial-air channel state information based on the echo signal (S406).

The pilot data transmitted by the IoT terminal 100 may be reflected by at least one of the terrestrial target 10 and the clutter 20. Therefore, the unmanned aerial vehicle 200 may receive the echo signal including at least one of the first echo signal reflected from the terrestrial target 10 and the second echo signal reflected from the clutter 20. The unmanned aerial vehicle 200 may estimate the terrestrial-air channel state information based on the difference between the predefined pilot pattern and the echo signal. In this case, by using the first echo signal as well as the second echo signal, the unmanned aerial vehicle 200 may estimate the terrestrial-air channel state information more accurately.

When operation S406 is performed, the unmanned aerial vehicle 200 collects the sensor data from the IoT terminal 100 based on the estimated channel state information (S408). In this case, the unmanned aerial vehicle 200 may collect the sensor data in real time during the data section Td through the uplink data communication.

When operation S408 is performed, the unmanned aerial vehicle 200 classifies the collected sensor data into the processable sensor data and the unprocessable sensor data (S410). In this case, the unmanned aerial vehicle 200 may calculate the energy consumption consumed for processing the corresponding sensor data based on the size of each piece of collected sensor data, and compare the size and energy consumption of each piece of sensor data with the data processing capacity and energy consumption of the first edge server. The unmanned aerial vehicle 200 may determine the sensor data exceeding the data processing capacity and energy consumption of the first edge server as the unprocessable sensor data.

When operation S410 is performed, the unmanned aerial vehicle 200 offloads the unprocessable sensor data to the satellite 300 (S412) and processes the processable sensor data on its own (S414). In this case, the first edge server mounted on the unmanned aerial vehicle 200 may process the processable sensor data.

When operation S412 is performed, the satellite 300 processes the unprocessable sensor data (S416) and transmits the processed data to the unmanned aerial vehicle 200 (S418). In this case, the second edge server mounted on the satellite 300 may process the unprocessable sensor data. The second edge server has a larger data processing capacity than the first edge server, and may process more sensor data than the first edge server.

When operation S418 is performed, the unmanned aerial vehicle 200 stores the self-processed data and the data processed by the satellite 300 during the flight (S420), and when the unmanned aerial vehicle 200 reaches the sky above the end user, which is the final destination (S422), the unmanned aerial vehicle 200 transmits the self-processed data and the data processed by the satellite 300 to the end user (S424).

As described above, according to one aspect of the present invention, by applying the joint communication and sensing and the space-air-ground integrated network to the satellite IoT system, it is possible to efficiently utilize the communication resources such as energy, hardware, algorithms, and signal processing and minimize the energy consumption of the unmanned aerial vehicle.

What is claimed is:

1. A satellite Internet on things (IoT) system, comprising:
a plurality of IoT terminals transmitting pilot data and sensor data;
an air communication node including a first edge server, receiving an echo signal for the pilot data, estimating terrestrial-air channel state information based on the echo signal, collecting sensor data based on the estimated channel state information, and classifying the collected sensor data into processable sensor data and unprocessable sensor data; and
a satellite including a second edge server, processing the unprocessable sensor data offloaded from the air communication node, and transmitting the processed data to the air communication node.

2. The satellite IoT system of claim 1, wherein the air communication node is an unmanned aerial vehicle.

3. The satellite IoT system of claim 2, wherein a joint communication and sensing framework is applied between each IoT terminal and the air communication node.

4. The satellite IoT system of claim 3, wherein each of the IoT terminal transmits the pilot data during a pilot section of a data frame, and transmits the sensor data during a data section.

5. The satellite IoT system of claim 1, wherein the IoT terminal transmits the pilot data in a direction of a terrestrial target, and
the echo signal includes at least one of a first echo signal reflected from the terrestrial target and a second echo signal reflected from clutter.

6. The satellite IoT system of claim 5, wherein the air communication node estimates the channel state information based on a difference between a predefined pilot pattern and the echo signal.

7. The satellite IoT system of claim 5, wherein the air communication node calculates energy consumption consumed for processing the corresponding sensor data based on a size of each piece of the collected sensor data, compares the size and energy consumption of each piece of sensor data with data processing capacity and energy consumption of the first edge server, and determines the processable sensor data and the unprocessable sensor data based on the comparison result.

8. The satellite IoT system of claim 1, wherein the air communication node processes the processable sensor data, receives data processed by the satellite, and transmits the processed data and the data processed by the satellite to an end user when the air communication node reaches the sky above the end user which is a final destination.

9. An air communication node, comprising:
a communication module;
a memory; and
a processor connected to the communication module and the memory,
wherein the processor receives an echo signal through the communication module, estimates terrestrial-air channel state information based on the echo signal, collects sensor data based on the estimated channel state information, classifies processable sensor data and unprocessable sensor data based on the collected sensor data, offloads the unprocessable sensor data to a satellite through the communication module, processes the processable sensor data, and receives data processed by the satellite.

10. The air communication node of claim 9, wherein the echo signal is a signal in which pilot data transmitted from an IoT terminal is reflected from at least one of a terrestrial target and clutter.

11. The air communication node of claim 9, wherein the processor estimates the channel state information based on a difference between a predefined pilot pattern and the echo signal.

12. The air communication node of claim 9, wherein the processor calculates energy consumption consumed for processing the corresponding sensor data based on a size of each piece of the collected sensor data, compares the size and energy consumption of each piece of sensor data with preset data processing capacity and energy consumption, and determines the processable sensor data and the unprocessable sensor data based on the comparison result.

13. The air communication node of claim 9, wherein the processor transmits the processed data and the data processed by the satellite to an end user when the processor reaches the sky above the end user which is a final destination.

14. A method of processing data in a satellite Internet on things (IoT) system, comprising:
transmitting, by each of a plurality of IoT terminals, pilot data and sensor data;
receiving, by an air communication node, an echo signal for the pilot data and estimating terrestrial-air channel state information based on the echo signal;
collecting, by the air communication node, sensor data based on the estimated channel state information;
classifying, by the air communication node, the collected sensor data into processable sensor data and unprocessable sensor data; and
offloading, by the air communication node, the unprocessable sensor data to a satellite.

15. The method of claim 14, wherein, in the transmitting, each of the IoT terminals transmits the pilot data during a pilot section of a data frame, and transmits the sensor data during a data section.

16. The method of claim 14, wherein the echo signal includes at least one of a first echo signal reflected from a terrestrial target and a second echo signal reflected from clutter.

17. The method of claim 16, wherein, in the estimating of the terrestrial-air channel state information, the air communication node estimates the channel state information based on a difference between a predefined pilot pattern and the echo signal.

18. The method of claim 14, wherein, in the classifying, the air communication node calculates energy consumption consumed for processing the corresponding sensor data based on a size of each piece of the collected sensor data, compares the size and energy consumption of each piece of sensor data with preset data processing capacity and energy consumption, and determines the processable sensor data and the unprocessable sensor data based on the comparison result.

19. The method of claim 14, further comprising, after the offloading, processing, by the air communication node, the processable sensor data and receiving the data processed by the satellite.

20. The method of claim 19, further comprising, after receiving the data processed by the satellite, transmitting, by the air communication node, the processed data and the data processed by the satellite to an end user when the air communication node reaches the sky above the end user which is a final destination.
